(19) United States
(12) Patent Application Publication
(10) Pub. No.: US 2016/0083235 A1
(43) Pub. Date: Mar. 24, 2016

(54) Capping-Decapping Tool for Screw-cap Tubes or Bottles

(71) Applicant: Ian Glasgow, Averill Park, NY (US)

(72) Inventors: Andrea Habura, Brunswick, NY (US); David Grinnell, Averill Park, NY (US); Ian Glasgow, Averill Park, NY (US)

(21) Appl. No.: 14/858,684

(22) Filed: Sep. 18, 2015

Related U.S. Application Data
(60) Provisional application No. 62/052,511, filed on Sep. 19, 2014.

(51) Int. Cl. B67B 3/20; B67B 7/18

(52) U.S. Cl. CPC B67B 3/2066; B67B 7/182

(57) ABSTRACT

This document describes a capping-decapping device for screw-capped tubes or vessels. Caps of screw-capped vessels are inserted into an inverted channel. A high-traction surface and a low-friction surface comprise opposite walls. The cap unscrews as it is pushed forward, and is held in the device once unscrewed. The vessel can be recapped by pulling the cap back toward the user. Additional features of the device may be added to improve usability, such as making it easier to open caps of varying diameters or to detect the presence of a cap in the device.

### BACKGROUND

This invention applies to small screw-cap tubes, such as microcentrifuge or storage tubes commonly used in laboratories. It can also be extended to other screw-cap tubes and bottles, especially those that can be held comfortably in one hand.

A common repetitive task for laboratory workers is to open a tube or bottle, add or withdraw liquids, and then close the container again. The addition or withdrawal of liquids is usually accomplished using a tool held in the other hand, such as a pipettor. For maximum control and accuracy, the tube often needs to be held in the hand as well. Some laboratory vessels are equipped with snap caps that are physically tethered to the bottle or tube and which are retained in the tube by friction, but many employ a threaded, screw-style cap that separates from the tube.

The use of such screw caps presents several problems to the laboratory worker. First, he or she must be trained to open and close the cap one-handed, so that the other hand is free to control the liquid manipulation device. The one-handed unscrewing motion requires practice and can be difficult for workers with conditions such as arthritis. When the container is in use, the cap must be held in a manner that prevents contamination from any contact.

If a single small tube is in use, the experimenter will typically hold the cap between two fingers, but this is cumbersome, limits movement, and makes it possible to drop the cap onto a contaminated surface or to spatter the inside with liquid from the pipettor or other manipulating device. If more than one tube must be open at once, the caps must be set down, risking contamination from surface contact and settling particles or droplets.

It would be very desirable to have a device that allowed the worker to remove and replace the cap of such a vessel using a simple, one-handed motion. Further, the cap should be securely retained in a position where contamination is very unlikely. Because an experimenter will use tubes or vessels made by multiple suppliers, the cap diameters will not be uniform. Therefore, the device should be able to accommodate a range of cap sizes that is typical for the vessel type (such as a microcentrifuge tube or a stock bottle). Finally, the device should be very easy to decontaminate, so that the worker can be sure that the contact surfaces are free of any materials that may cause experimental failure.

While the primary application of such a device would be in laboratory settings, it may also be useful for people in other industries or in home settings. It would improve efficiency in any environment where a screw-cap vessel must be used but the cap cannot conveniently be set down on a surface.

### SUMMARY OF THE INVENTION

The invention entails a device with an inverted channel into which the threaded cap of a vessel can be pushed. The channel is equipped with one high traction surface and one low-friction surface. The cap unscrews as the vessel is pushed forward, and the cap is held in the device once unscrewed. The vessel can be recapped by placing it up into the cap and pulling the vessel back toward the user.

Several advantages of one or more aspects of the current invention are as follows: ease of capping and decapping of tubes (which encompasses speed, less requirement for training, and ergonomic advantages); reduced risk of contamination of caps and tubes; and increased precision of handling of tubes. Further advantages of one or more aspects of the current invention will become apparent from a consideration of the drawings and the detailed enclosure.

### DRAWINGS

FIG. 1 is perspective view of the features of one embodiment of the invention.

FIG. 2 is a cutaway view of the embodiment in FIG. 1.

FIG. 3 is an exploded view of one embodiment of the invention.

FIG. 4 is a perspective view showing multiple devices for handling different size or shape caps, and includes a means for connecting several devices together.

FIG. 5 is a perspective view of another embodiment of the invention.

### DETAILED DESCRIPTION OF THE DRAWINGS

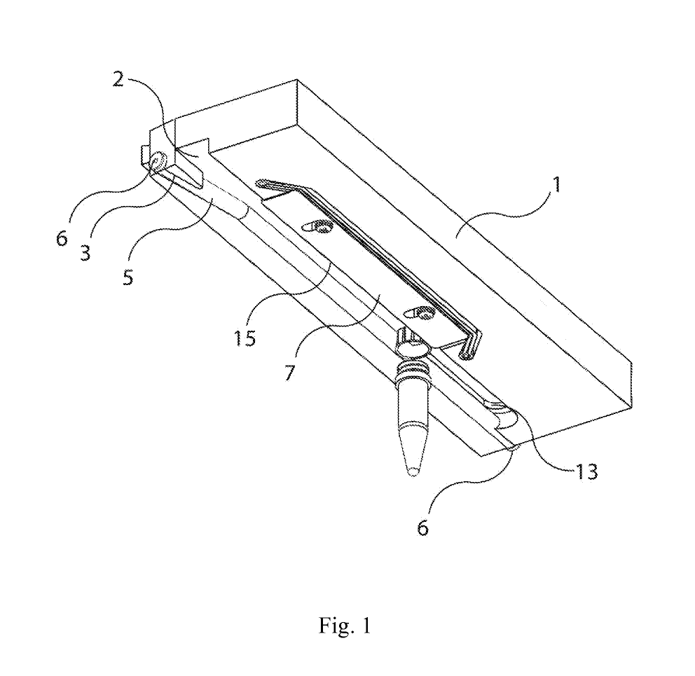

FIG. 1. is a perspective view of one embodiment of the device. The device comprises a mounting block (1) which is fitted with a resilient member, such as soft rubber tubing (5) and a slider (7) that is spring-loaded. The soft rubber tubing (5) forms one wall, with a high traction surface, of an inverted channel (2). The opposing wall is a low-friction surface (15), of the slider (7). The base of the inverted channel (2) is formed by the mounting block (1). A groove (3) runs alongside and partially contiguous with the inverted channel (2).

The soft rubber tubing (5) is capped with barbed fittings (6) at both ends, and is stretched between the ends of groove (3). The soft rubber tubing (5) can be removed for cleaning or replacement. The distal end of the channel is the threaded cap retention region (13).

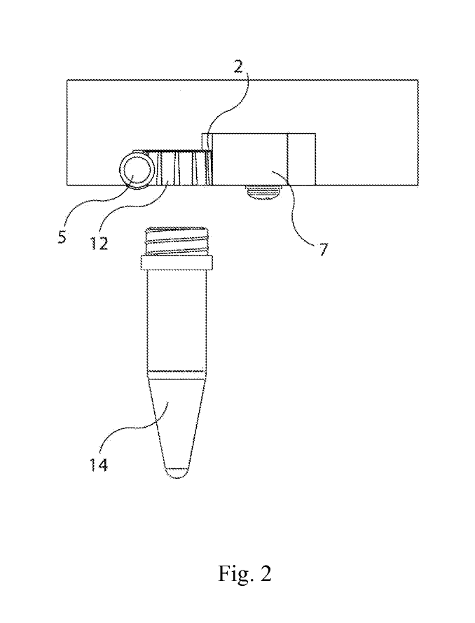

FIG. 2 is a cutaway view of the device during removal of the threaded cap (12) from the vessel (14). The threaded cap (12) of the sample tube or vessel (14) is inserted into the inverted channel (2), with the soft rubber tubing (5) providing traction and the slider (7) forcing the threaded cap (12) against the soft rubber tubing (5). The user pushes the vessel (14) toward the distal end of the inverted channel (2) to unscrew the threaded cap (12). Once the threaded cap (12) is unscrewed from the vessel (14), the force provided by the slider (7) will continue to hold the threaded cap in the inverted channel (2). To re-threaded cap the vessel (14), the user places the vessel (14) into the threaded cap (12) and pulls the vessel (14) towards the proximal end of the inverted channel (2).

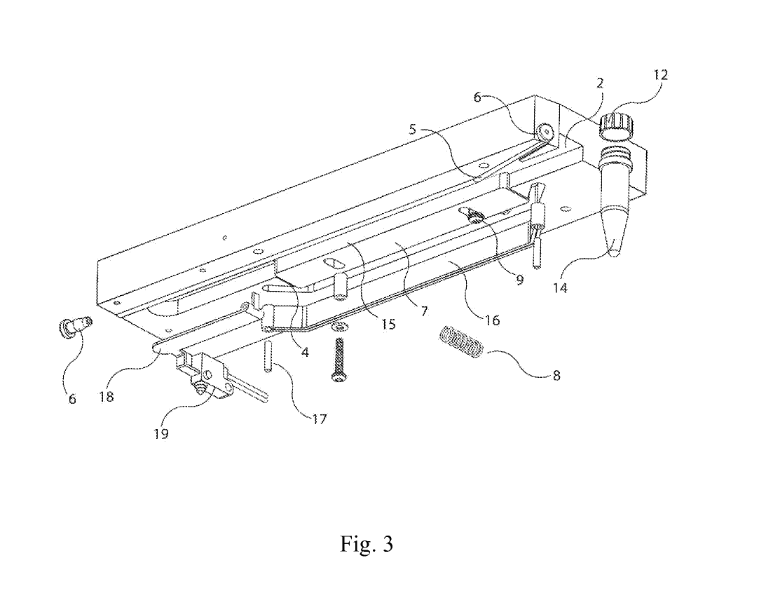

FIG. 3 is an exploded view of one embodiment of the device. The inverted channel (2) is wide enough at the entrance to accept the threaded cap (12) which is threaded onto the vessel (14). The soft rubber tubing (5) threaded capped with barbed fittings (6) provides traction, causing the threaded cap (12) to unscrew from the vessel (14) as the vessel (14) is pushed towards the distal end of the inverted channel (2). The slider (7) with slots or holes for springs (8) and with slots for fasteners (9) is placed in the recess (4). The springs (8) push the slider (7) towards the soft rubber tubing (5), thereby making the inverted channel (2) narrower. An elastic band or other tensioning component (16) held by fasteners or pins (17) may also be used to push the slider (7).

When a threaded cap (12) is in the channel (2), the low-friction surface (15) of the slider (7) contacts the threaded cap (12). The soft rubber tubing (5) contacts the diametrically opposed region of the threaded cap (12). The presence of the threaded cap (12) in the device may be indicated to the user by a mechanism such as a lever (18) that makes contact with an electrical switch (19) when the lever is pushed by the threaded cap (12).

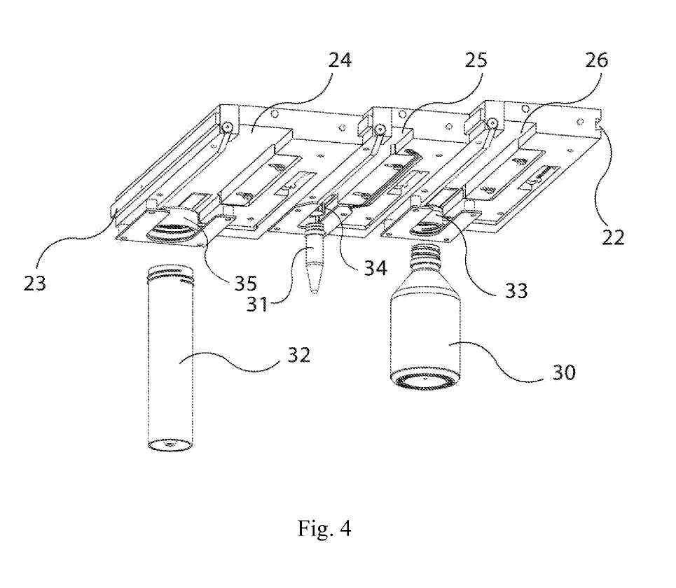

FIG. 4 is a perspective view showing multiple devices, each with a separate inverted channel (24), (25), and (26). Note that these channels can be of different depths and widths in order to accommodate screw threaded caps (33), (34), and (35) of different heights and diameters, corresponding to vessels (30), (31), and (32) of different shapes or sizes. Additionally, devices may be linked together by use of a tongue-and-groove as shown, with groove (22) and tongue (23), or other comparable method.

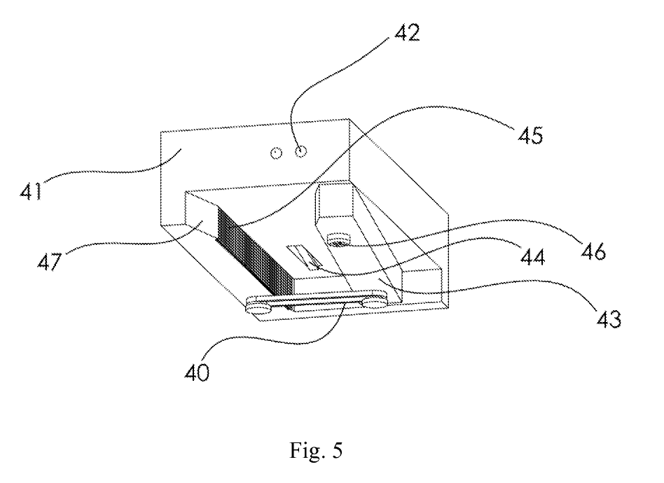

FIG. 5 is a perspective view of another embodiment of the device. The mounting block (41) has a wall with a high traction surface (45). In this figure, the high traction surface (45) is composed of multiple vertical ridges that are located along its length. The wall is tapered at the entrance region (47). An elastic band (40) causes the pivot block (43) to pivot about the screw or pin (46) towards the wall with the high traction surface (45). The pivot block (43) serves the same function of the slider (7) in FIGS. 1, 2, and 3. When a cap is in the channel, it displaces the lever (44) of a switch, and an electronic circuit turns on an LED (42). The second LED can be of a different color to indicate the absence of a cap.

### DESCRIPTION

The device enables the user to unscrew caps from sample tubes and screw caps back onto sample tubes, using just one hand. This is very useful for people working in laboratories that do not have a second, free hand. The device also holds the caps while the user is working with the sample tube.

The principal of the device is that the user slides the sample tube with its cap into a channel. One surface of the channel grips the cap, while the opposing surface and the base of the inverted channel have very little friction, thus the cap unscrews as the sample tube is pushed further into the channel. Once the cap is unthreaded from the sample tube, the spring force and gripping surface in the channel enable the cap to be retained in the device. When the user is ready for the cap to be threaded back onto the sample tube, the user places the sample tube under the cap, and exerts a slight upward force as they pull the sample tube towards the entrance of the channel and out of the channel. Working in reverse, the cap does not slip along the high traction surface, but does slip along the low friction surface, and thus turns as it travels back through the channel, and leaves the channel threaded onto the sample tube.

Either the high traction surface of the low-friction surface should be spring loaded. Without opposing surfaces in contact with the cap or the high traction surface and the base of the channel in contact with the cap, the cap tends not to remain flat and then does not unscrew or screw completely, or tries to cross-thread. With the high-traction surface spring loaded, the user has to judge how much force to apply when unthreading or threading caps. Therefore the better surface to spring load is the low-friction surface. The spring force is sufficient to retain the cap in the device once the sample tube is removed, but not enough to significantly deform the cap.

The device also possesses a surface or a bracket or extensible arm by which it may be affixed to the underside of a shelf, or to a wall or side panel, within easy reach of the experimenter. Attachment may be accomplished using an adhesive, one or more magnets, a hook-and-loop closure such as Velcro®, or any other suitable attachment system or substance. The device may be mounted in any orientation that provides maximum convenience to the worker. It may be mounted either horizontally, or at an angle so that the channel slopes downward or upward.

All surfaces which come into contact with the screw cap are completely cleanable with typical laboratory decontamination solutions. The components subject to wear (such as, but not limited to, springs and the high-friction surface) are also replaceable without replacing the entire unit.

The channel may be straight or curved, and may have sides that are parallel or that narrow progressively.

The material of the main block of the device may be transparent to facilitate visualization of the cap.

The device may have one or more separate channels, of the same size or of different sizes to accommodate different cap diameters and cap heights. The sides of individual units may have tongue-and-channel fittings or other attachments to allow multiple units to be securely locked together.

In another embodiment, the channels or channel entrances can have profiles to allow only certain shaped caps and/or certain shaped vessels to enter.

In another embodiment, the channel path can be curved or have some other non-straight path.

In another embodiment, the channel can be tapered to accommodate a range of cap diameters. In this embodiment, a wider cap may be gripped starting at the entrance of the channel and fully unscrewed without reaching (or fitting) to the end of the channel, while a narrow cap would initially be gripped part way along the length of the channel and would reach the fully unscrewed state near the distal end of the channel.

In another embodiment, the single channel could accommodate a range of cap sizes with the aid of a step in the profile of the channel. In this version, a small cap would fit in the narrow upper part of the channel and a larger cap in the wider lower part of the channel.

In another embodiment, a component of the device could be employed to indicate the position or presence of one or more caps in the channel. Possible embodiments include, but are not limited to, a mechanical indicator such as a flag which protrudes or appears in a window (the color in the window thus changes from one color to another contrasting color), or an LED or other electronic component that changes state when a cap is present. Such mechanical or electronic indicators may detect the position of a cap by displacement of a mechanical object such as a crossbar fitted in the channel, by a linear potentiometer, or by other appropriate mechanical or electronic means.

In another embodiment, the channel has an extended cap retention region, to retain several caps.

In another embodiment, the channel has an extended cap retention region and a cap position indicator as mentioned above. A series of indicators could be used to indicate if at least one cap was in the channel, or to indicate the number of caps retained in the channel, as well as whether or not the retention region was full or had the capacity to retain another cap.

In another embodiment, the channel is without a spring loaded wall. This embodiment relies upon the user to apply sufficient force and friction between the cap and high-friction surface.

In another embodiment, the high traction surface has ridges or knurls and is not resilient.

In another embodiment, there is a notch, projection, or other shape added to the front or side of the device, to aid in uncapping of snap-cap style tubes.

We claim:

1. A device for removing and replacing a threaded cap from a vessel comprising:
a. a mounting block with a horizontal surface forming the base of a channel;
b. a compression block with one low-friction surface that forms one wall of said channel;
c. a high traction surface forming the opposing wall of said channel;
d. a means, from a set of spring, elastic band, or flexing element, for forcing said low-friction surface towards the high-traction surface;
e. the entrance of said channel is wider than said threaded cap; and
f. the depth of said channel is on the order of the height of said threaded cap.

2. The device of claim 1, whereby said high-traction wall has ridges.

3. The device of claim 1, whereby a resilient member covers said high-traction wall

4. The device of claim 3, whereby said resilient member is replaceable.

5. The device of claim 1, whereby said compression block pivots.

6. The device of claim 1, whereby said channel is not straight.

7. The device of claim 1, whereby said proximal end of said channel is wider than the distal end of said channel.

8. The device of claim 1, whereby the geometry of said channel varies along the length of said channel.

9. The device of claim 1, whereby there are a plurality of said channels.

10. The device of claim 9, whereby said multiple channels have different geometries, whereby said device can be used with different sizes of said threaded cap.

11. The device of claim 1, with a means for attachment to another surface.

12. The device of claim 1, with a means for attaching said devices to each other.

13. The device of claim 1, with a means for indicating the presence of said threaded cap such as an LED or movable flag.
